(19) United States
(12) Patent Application Publication
(10) Pub. No.: US 2026/0292660 A1
(43) Pub. Date: Sep. 24, 2026

(54) METHOD FOR BROADCASTING AUDIO BROADCAST TRANSMISSION, METHOD FOR FORWARDING AUDIO BROADCAST STREAMS, AND ASSOCIATED ELECTRONIC DEVICES

(71) Applicant: MediaTek Singapore Pte. Ltd., Singapore (SG)

(72) Inventors: Biwei Che, Chengdu (CN); Hongwei Du, Chengdu (CN); Subin Ai, Chengdu (CN)

(73) Assignee: MediaTek Singapore Pte. Ltd., Singapore (SG)

(21) Appl. No.: 19/363,662

(22) Filed: Oct. 21, 2025

(30) Foreign Application Priority Data
Mar. 18, 2025 (CN) 202510324230.1

(51) Int. Cl. H04W 48/10; H04W 28/06; H04W 48/16; H04W 72/30

(52) U.S. Cl. CPC H04W 48/10; H04W 28/06; H04W 48/16; H04W 72/30

(57) ABSTRACT

A method for broadcasting an audio broadcast transmission by an electronic device includes: determining text information as a first part of advertising data of a first extended advertising (EA) auxiliary packet or a first part of advertising data of a first periodic advertising (PA) packet, wherein the text information indicates a help keyword; determining audio information as audio data of a first broadcast isochronous stream (BIS), wherein the audio information includes audio data of at least one speech seeking for help; obtaining position information of the electronic device as a second part of the advertising data of the first EA auxiliary packet or a second part of the advertising data of the first PA packet; and broadcasting the audio broadcast transmission, wherein the audio broadcast transmission includes an EA packet, the first EA auxiliary packet, the first PA packet, and the first BIS.

### BACKGROUND

The present invention is related to broadcast audio technology, and more particularly, to a method for broadcasting an audio broadcast transmission, a method for forwarding audio broadcast streams, and associated electronic devices.

In recent years, accidents of outdoor camping or natural disasters have occurred frequently. In the absence of internet access, an existing method may use a satellite phone, a wireless intercom, an alarm system, or a professional rescue equipment to call for help. These devices, however, are not available to the general public. The existing method may also use the Bluetooth function of an electronic device (e.g., a mobile phone) to solve a scenario application problem in distress when there is no network. For example, an electronic device of a user can establish a connection between the electronic device and a reception device through Basic Rate (BR)/ Enhanced Data Rate (EDR) asynchronous connection (ACL) or low energy asynchronous connection (LE ACL), in order to transmit SOS information to the reception device. The disadvantage is that the electronic device of the user must be located near the reception device to achieve the above information transmission, and there is a one-to-one restriction between the electronic device and the reception device due to the ACL link, which results in a limited information transmission distance.

### SUMMARY

It is therefore one of the objectives of the present invention to provide a method for broadcasting an audio broadcast transmission, a method for forwarding audio broadcast streams, and associated electronic devices, in order to address the above-mentioned issues.

According to an embodiment of the present invention, a method for broadcasting an audio broadcast transmission by an electronic device is provided. The method comprises: determining text information for acting as a first part of advertising data of a first extended advertising (EA) auxiliary packet or a first part of advertising data of a first periodic advertising (PA) packet, wherein the text information indicates a help keyword; determining audio information for acting as audio data of a first broadcast isochronous stream (BIS), wherein the audio information comprises audio data of at least one speech seeking for help; obtaining position information of the electronic device for acting as a second part of the advertising data of the first EA auxiliary packet or a second part of the advertising data of the first PA packet, wherein the position information of the electronic device indicates a position of the electronic device; and broadcasting the audio broadcast transmission, wherein the audio broadcast transmission comprises an EA packet, the first EA auxiliary packet, the first PA packet, and the first BIS.

According to an embodiment of the present invention, a method for forwarding audio broadcast streams by an electronic device is provided. The method comprises: receiving an EA packet, an EA auxiliary packet, a PA packet, and a BIS from a first electronic device, wherein the broadcast transmission comprises the EA packet, the EA auxiliary packet, the PA packet, and the BIS; a first part of advertising data of the EA auxiliary packet or a first part of advertising data of the PA packet carries text information; the text information indicates a help keyword; a second part of the advertising data of the EA auxiliary packet or a second part of the advertising data of the PA packet carries position information of the first electronic device; the position information of the electronic device indicates a position of the first electronic device; the BIS carries the audio broadcast streams; and the audio broadcast streams carry audio data of at least one speech seeking for help; determining whether the audio broadcast streams need to be forwarded based on at least one of the EA packet, the EA auxiliary packet, the PA packet, and the audio data of the at least one speech seeking for help; and in response to the audio broadcast streams needing to be forwarded, transmitting an intermediate audio broadcast transmission according to the audio broadcast transmission, wherein the intermediate audio broadcast transmission comprises an intermediate EA packet, an intermediate EA auxiliary packet, an intermediate PA packet, and an intermediate BIS; and the intermediate BIS carries the audio broadcast streams.

According to an embodiment of the present invention, an electronic device is provided, wherein the electronic device comprises a processor and a wireless communication module. The processor is configured to: determine text information for acting as a first part of advertising data of a first EA auxiliary packet or a first part of advertising data of a first PA packet, wherein the text information indicates a help keyword; determine audio information for acting as audio data of a first BIS, wherein the audio information comprises audio data of at least one speech seeking for help; and obtain position information of the electronic device for acting as a second part of the advertising data of the first EA auxiliary packet or a second part of the advertising data of the first PA packet, wherein the position information of the electronic device indicates a position of the electronic device. The wireless communication module is configured to broadcast the audio broadcast transmission, wherein the audio broadcast transmission comprises an EA packet, the first EA auxiliary packet, the first PA packet, and the first BIS.

One of the benefits of the present invention is that, the electronic device of the present invention supporting a broadcast media sender (BMS) can broadcast an audio broadcast transmission with more information, wherein an EA auxiliary packet or a PA packet of the audio broadcast transmission includes text information, the EA auxiliary packet or the PA packet of the audio broadcast transmission includes position information of the electronic device, a BIS of the audio broadcast transmission includes audio data. In addition, there is no need for a specific protocol between an audio source device and a reception device for audio broadcast transmission transception. More particularly, electronic devices supporting the BMS can broadcast the audio broadcast transmission, electronic devices supporting a broadcast media receiver (BMR) can receive the audio broadcast transmission, and electronic devices supporting both the BMS and the BMR can receive and forward the audio broadcast transmission, wherein a propagation distance of the audio broadcast transmission can be increased by forwarding the audio broadcast transmission.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating internal layer architecture of an audio broadcast transmission according to an embodiment of the present invention.

FIG. 3 is a flow chart of a method for broadcasting an audio broadcast transmission according to an embodiment of the present invention.

FIG. 4 is a flow chart of a method for receiving an audio broadcast transmission according to an embodiment of the present invention.

FIG. 5 is a flow chart of a method for receiving an audio broadcast transmission according to an embodiment of the present invention.

FIG. 6 is a flow chart of a method for relaying an audio broadcast transmission according to an embodiment of the present invention.

FIG. 7 is a diagram illustrating an example of broadcasting/forwarding an audio broadcast transmission according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms "include" and "comprise" are used in an open-ended fashion, and thus should be interpreted to mean "include, but not limited to ...".

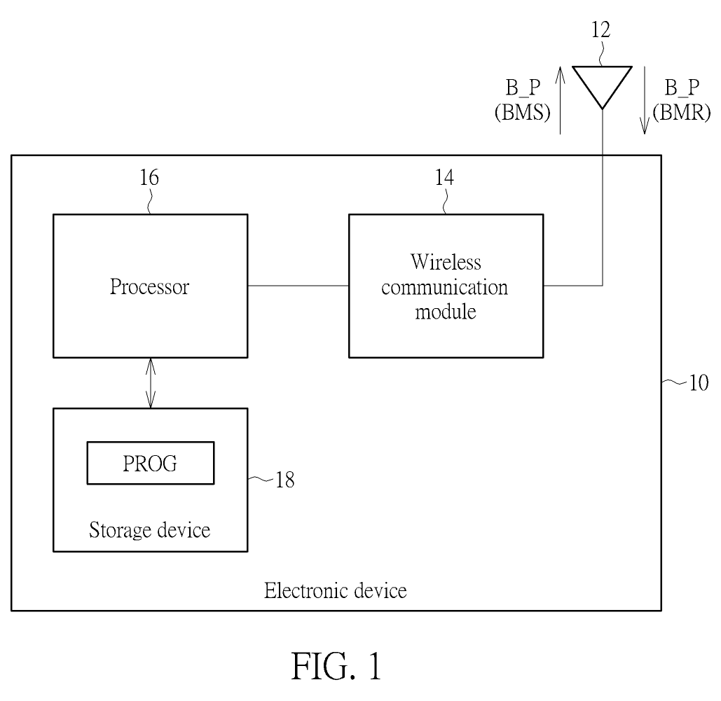

FIG. 1 is a diagram illustrating an electronic device 10 according to an embodiment of the present invention. Examples of the electronic device 10 may include, but are not limited to: a multifunctional mobile phone and a wearable device. As shown in FIG. 1, the electronic device 10 may include an antenna 12, a wireless communication module 14, a processor 16, and a storage device 18. The electronic device 10 complies with version 5.2 or above of the Bluetooth communication standard formulated by the Bluetooth Special Interest Group (SIG). Therefore, the electronic device 10 can support a Bluetooth broadcast audio function (e.g., an Auracast broadcast audio function). That is, under a situation that the electronic device 10 acts as a broadcast media sender (BMS), an audio broadcast transmission B_P can be transmitted over the air via the antenna 12 and the wireless communication module 14, in order to broadcast the audio broadcast transmission B_P to an unlimited number of reception devices, wherein each reception device acts as a broadcast media receiver (BMR). In addition, under a situation that the electronic device 10 supports function of the BMR, the electronic device 10 may perform a scanning operation to detect whether there is a receivable audio broadcast transmission from other device. It should be noted that, if the electronic device 10 supports both functions of the BMS and the BMR, after the audio broadcast transmission B_P is received from other device, the electronic device may be further arranged to relay the audio broadcast transmission B_P in order to increase a propagation distance of the content of the audio broadcast transmission B_P.

The processor 16 may be a single-core processor or a multi-core processor. The storage device 18 is a non-transitory machine-readable medium, and is arranged to store computer program code PROG. The processor 16 is equipped with software execution capability. When loaded and executed by the processor 16, the computer program code PROG instructs the processor 16 to perform methods for broadcasting, receiving, and relaying the audio broadcast transmission B_P as proposed by the present invention. The electronic device 10 may be regarded as a computer system using a computer program product that includes a computer-readable medium containing the computer program code PROG. That is, the methods of the present invention may be embodied on the electronic device 10.

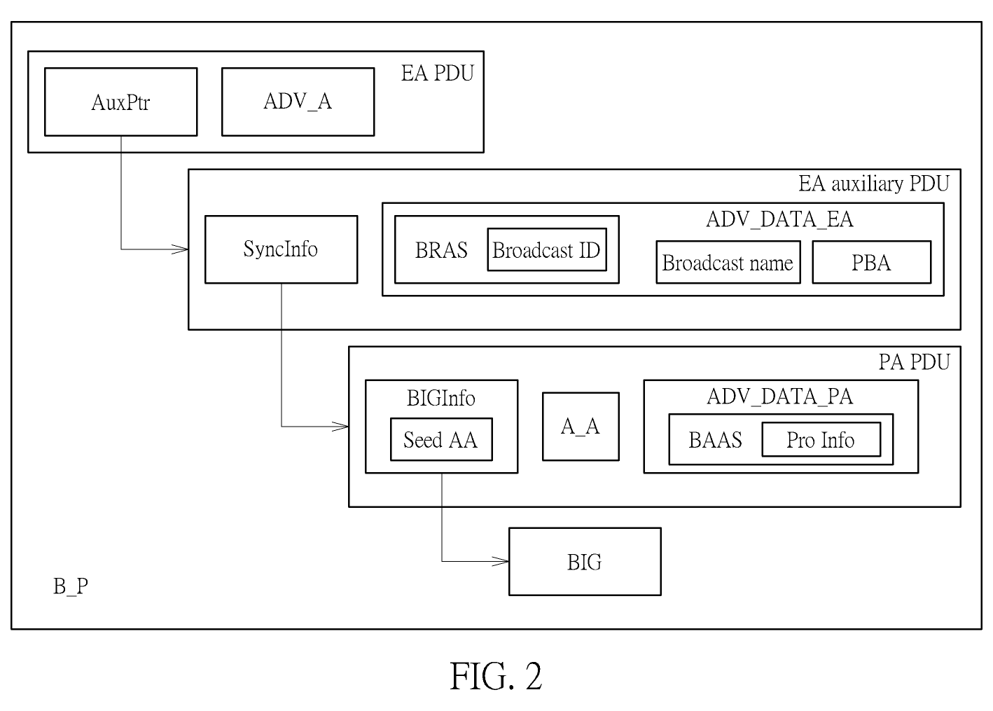

FIG. 2 is a diagram illustrating layer architecture of the audio broadcast transmission B_P according to an embodiment of the present invention. The one or more broadcast audio streams are transmitted by a broadcast sender and are transported by using broadcast isochronous streams (BISes) within a broadcast isochronous group (BIG). In order to transmit the broadcast audio streams, the broadcast sender also transmits an extended advertising (EA) packet, an EA auxiliary packet, and periodic advertising (PA) packets. As shown in FIG. 2, an audio broadcast transmission B_P has four-layer architecture, such as a first layer FL, a second layer SL, a third layer TL, and a fourth layer FOL. The first layer FL includes an EA protocol data unit (PDU), the second layer SL includes an EA auxiliary PDU, the third layer TL includes a PA PDU, and the fourth FOL includes a BIG. Specifically, the audio broadcast transmission B_P may include multiple EA auxiliary packets sent periodically, multiple PA packets sent periodically, and multiple BIGs sent periodically.

The first layer FL includes an EA PDU. Through a primary advertising channel, the EA PDU may be transmitted, wherein the EA PDU may include an AuxPtr field (labeled as “AuxPtr” in FIG. 2) and an advertising address ADV_A, the AuxPtr field contains data for helping a scanning device to perform a synchronization reception to the EA auxiliary PDU, and the advertising address ADV_A may indicate a device address of a sender sending the EA advertising PDU. For example, when the scanning device scans and detects that the advertising PDU includes the AuxPtr field, the scanning device may receive the EA auxiliary PDU at a time point determined based on the AuxPtr field.

The second layer SL includes an EA auxiliary PDU. The EA auxiliary PDU may include a SyncInfo field (labeled as “SyncInfo” in FIG. 2) and advertising data ADV_DATA_EA. The advertising data ADV_DATA_EA in the EA auxiliary PDU may include a broadcast audio announcement service (labeled as “BRAS” in FIG. 2), a broadcast name, and a Public Broadcast Announcement (PBA), wherein the BRAS includes a broadcast identification (ID), and the broadcast ID is used for the scanning device to find the broadcast audio streams. The broadcast ID may identify the broadcast audio stream. The broadcast name may indicate a help keyword. The broadcast name may be a human readable string. The SyncInfo field may contain data for helping the scanning device to perform a synchronization reception to a PA PDU. For example, the scanning device may receive the PA PDU at a time point determined based on the SyncInfo field. The EA auxiliary PDU may be transmitted via one or more general-purpose channels.

The third layer TL includes a PA PDU. The PA PDU may include a BIGInfo field (labeled as “BIGInfo” in FIG. 2), an access address A_A, and advertising data ADV_DATA_PA, wherein the access address A_A may indicate a train of periodically transmitted PA PDUs. The advertising data ADV_DATA_PA may include a basic audio announcement service (labeled as “BAAS” in FIG. 2), wherein the basic audio announcement service may include program information (labeled as “Pro Info” in FIG. 2) and parameters of the broadcast audio streams, such as Codec parameters, interval information, and the number of broadcast isochronous streams (BISes). The BIGInfo field includes data for helping the scanning device to performing a synchronization reception to a broadcast isochronous group (BIG). The program information may indicate a help keyword. For example, the scanning device may receive a broadcast isochronous group (BIG) at a time point determined based on the BIGInfo field. The PA PDU may be transmitted via one or more general-purpose channels.

The fourth FOL includes at least one BIG. The BIG contains one or more broadcast isochronous streams (BISes) used to transport broadcast audio streams, and each BIS may carry audio data. The BIG may be transmitted via one or more general-purpose channels.

It should be noted that, the interval information may indicate the time interval for the electronic device to periodically send a BIG. For an emergency rescue scenario without a network, the time interval can be extended in order to reduce the number of times BIG is transmitted per unit time, thereby reducing the power consumption.

In addition, the processor 16 may obtain position information of an audio source device (i.e., an electronic device first broadcasting the audio broadcast transmission B_P) for acting as a part of the advertising data ADV_DATA_EA in the EA auxiliary packet or a part of the advertising data ADV_DATA_PA in the PA packet. Specifically, the advertising data ADV_DATA_EA or the advertising data ADV_DATA_PA includes a location field for carrying the position information of an audio source device. Alternatively, the position information of an audio source device acts as metadata M_DATA in the basic audio announcement service included in the advertising data ADV_DATA_PA. That is, the metadata M_DATA may carry the position information (e.g., a global positioning system (GPS) coordinate) of the electronic device, and more particularly, may carry at least one global navigation satellite system (GNSS) coordinate supported by the electronic device (e.g., a BeiDou coordinate and a Galileo coordinate).

The methods proposed by the present invention may be applied to the emergency rescue scenario without the network. For example, the BIS in the audio broadcast transmission may carry audio information as SOS information, and more particularly, may carry a SOS speech recorded by the user. In addition, the computer program code PROG stored in the storage device 18 may include an artificial intelligence (AI) algorithm. When loaded and executed by the processor 16, the AI algorithm instructs the processor 16 to translate an original speech (e.g., the SOS speech) into at least one translated speech, which can further increase the probability of successful rescue. In some embodiments, the at least one translated speech and the original speech are different countries’ languages. As a result, the audio information carried by the BIS may include multiple-language speeches.

In addition, the processor 16 may determine text information related to a help keyword for acting as a part of the advertising data ADV_DATA_EA of the EA auxiliary packet or a part of the advertising data ADV_DATA_EA of the PA packet, so that a user of a reception device may quickly determine whether the audio broadcast transmission B_P carries the SOS information, and may further determine whether it is necessary to parse the fourth layer FOL of the audio broadcast transmission B_P for checking the SOS information carried by the BIS. Specifically, the text information related to the help keyword may act as a broadcast name in the advertising data ADV_DATA_EA of the EA auxiliary packet or a part of the program information in the advertising data ADV_DATA_PA of the PA packet.

For a case where the electronic device 10 is an audio source device supporting the Auracast broadcast audio function, and acts as the BMS, the processor 16 may be arranged to determine the text information for acting as the first part of the advertising data ADV_DATA_EA of the EA auxiliary packet or the first part of advertising data ADV_DATA_PA of the PA packet, determine the audio information for acting as the audio data of the BIS, and obtain the position information of the electronic device 10 for acting as the second part of the advertising data ADV_DATA_EA of the EA auxiliary packet or the second part of the advertising data ADV_DATA_PA of the PA packet. The wireless communication module 14 may broadcast the audio broadcast transmission B_P over the air via the antenna 12.

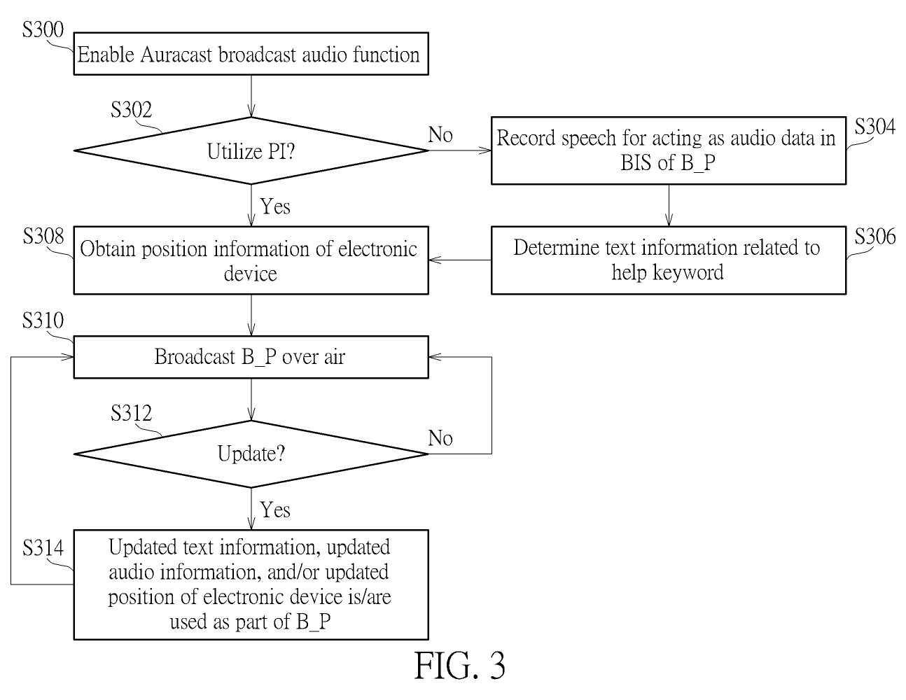

Specifically, refer to FIG. 3. FIG. 3 is a flow chart of a method for broadcasting the audio broadcast transmission B_P according to an embodiment of the present invention, wherein the method may be applied to the emergency rescue scenario without the network. Provided that the result is substantially the same, the steps are not required to be executed in the exact order shown in FIG. 3. For example, the method shown in FIG. 3 may be employed by the electronic device 10 (more particularly, the processor 16 and the wireless communication module 14, wherein the processor 16 may be referred to as a host, and the wireless communication module 14 may include a bluetooth (BT) controller) shown in FIG. 1, wherein the electronic device 10 may act as the BMS. For better comprehension, the method may be illustrated with the flow shown in FIG. 3, but the present invention is not limited thereto. In some embodiments, one or more steps may be added, deleted, or changed in the flow shown in FIG. 3.

In Step S300, the Bluetooth broadcast audio function (e.g., the Auracast broadcast audio function) of the electronic device 10 is enabled. For example, the Auracast broadcast audio function may be enabled by clicking a button on an interface of the electronic device 10 (e.g., an application (APP) running on the electronic device 10 or a system interface of the electronic device 10).

The storage device 18 may store predetermined information PI in advance, wherein the predetermined information PI may include predetermined text information PTI and/or predetermined audio speech PAR. For the emergency rescue scenario without the network, the predetermined text information PTI may include a help keyword, and the predetermined audio speech PAR may include a pre-recorded SOS speech, but the present invention is not limited thereto.

In Step S302, it is determined whether to utilize the predetermined information PI as data within the audio broadcast transmission B_P (labeled as “Utilize PI?” in FIG. 3 for brevity). If Yes, Step S308 is entered; if No, Step S304 is entered. For example, the predetermined text information PTI may act as the first part of the advertising data ADV_DATA_EA of the EA auxiliary packet or the first part of the advertising data ADV_DATA_PA of the PA packet included in the audio broadcast transmission B_P, and the predetermined audio speech PAR may act as the audio data in the BIS of the audio broadcast transmission B_P.

In Step S304, a speech (e.g., a SOS speech) is recorded for acting as the audio data in the BIS of the audio broadcast transmission B_P.

In Step S306, a help keyword is received by the electronic device 10, and text information related to the help keyword is determined for acting as the first part of the advertising data ADV_DATA_EA of the EA auxiliary packet or the first part of the advertising data ADV_DATA_PA of the PA packet included in the audio broadcast transmission B_P.

In this embodiment, the interface of the electronic device 10 may display an option to ask the user whether to use the predetermined text information PTI as the text information to be transmitted. If the user selects Yes, the predetermined text information PTI is used as the first part of the advertising data ADV_DATA_EA in the EA auxiliary packet or the first part of the advertising data ADV_DATA_PA in the PA packet included in the audio broadcast transmission B_P. If the user selects No, the electronic device 10 prompts the user to enter a help keyword. The electronic device 10 receives the help keyword entered by the user for acting as the first part of the advertising data ADV_DATA_EA of the EA auxiliary packet or the first part of the advertising data ADV_DATA_PA of the PA packet included in the audio broadcast transmission B_P.

The interface of the electronic device 10 may display an option to ask whether to use the predetermined audio speech PAR as the audio information to be transmitted. If the user selects Yes, the predetermined audio speech PAR is used as the audio data of the BIS in the audio broadcast transmission B_P. If the user selects No, the electronic device 10 records the user's speech and determines that the recorded user's speech is used as the audio data of the BIS in the audio broadcast transmission B_P.

In Step S308, the position information of the electronic device 10 is obtained for acting as the second part of the advertising data ADV_DATA_EA of the EA auxiliary packet or the second part of the advertising data ADV_DATA_PA of the PA packet included in the audio broadcast transmission B_P.

In Step S310, the audio broadcast transmission B_P is broadcasted over the air via the wireless communication module 14.

The packets in the audio broadcast transmission B_P may be broadcasted in different broadcast periods, for example, the EP packet and the EP auxiliary packet are broadcast every 150 ms, the PA packet is broadcast every 120 ms, and the BIG is broadcast every 30 ms.

In Step S312, it is determined whether an instruction indicating the updating of the text information and/or an instruction indicating the updating of the audio information is received, and it is determined whether the position of the electronic device 10 is updated (labeled as “Update?” in FIG. 3 for brevity). If Yes, Step S314 is entered; if No, Step S310 is entered.

In Step S314, if an instruction indicating the updating of the text information is received, the updated text information is used as the first part of the advertising data ADV_DATA_EA of the EA auxiliary packet or the first part of the advertising data ADV_DATA_PA of the PA packet transmitted after the time point of receiving the instruction; if an instruction indicating the updating of audio information is received, the updated audio information is used as the audio data in the BIS transmitted after the time point of receiving the instruction; if it is determined that the position of the electronic device 10 is updated, the updated position of the electronic device 10 is used as the second part of the advertising data ADV_DATA_EA of the following EA auxiliary packet or the second part of the advertising data ADV_DATA_PA of the following PA packet.

In this step, the updated speech may be recorded by the user, and the updated text information may be provided by the user.

Since a person skilled in the pertinent art can readily understand details of the steps after reading above paragraphs, further description is omitted here for brevity.

For a case where the electronic device 10 is an audio intermediate device supporting the Auracast broadcast audio function, and acts as both the BMS and the BMR, the wireless communication module 14 may be arranged to scan the EA packet, the EA auxiliary packet, the PA packet, and the BIG, and transmit a report to the processor 16. The processor 16 may be arranged to determine whether to relay the audio broadcast transmission B_P via the wireless communication module 14 based on at least the report.

The following two schemes are provided for determining whether the receiving audio broadcast transmission or the received audio broadcast transmission needs to be relayed.

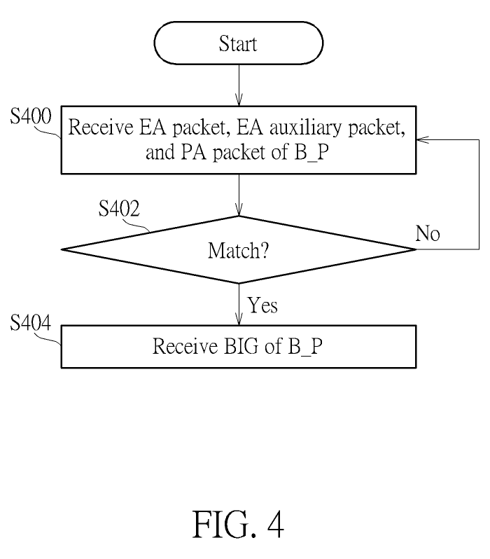

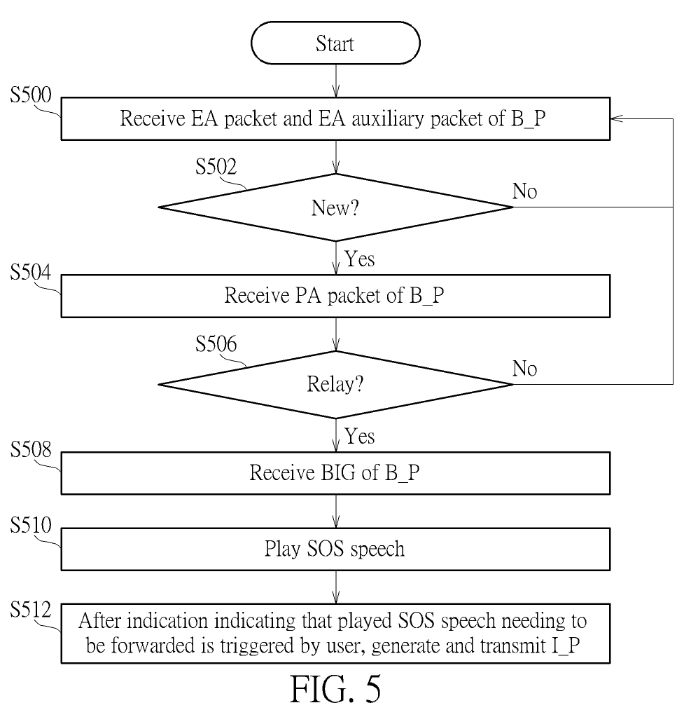

FIGS. 4 and 5 illustrate flow charts of a method for receiving the audio broadcast transmission B_P according to an embodiment of the present invention, wherein the method may be implemented by an intermediate device determining to relay the audio broadcast transmission.

FIG. 4 shows a first scheme. In the first scheme, the intermediate audio device determines whether to relay the audio broadcast transmission B_P based on the information stored in the intermediate audio device.

In Step S400, a scanning operation is performed by the intermediate audio device to receive an EA packet, an EA auxiliary packet, and a PA packet of the audio broadcast transmission B_P.

In Step S402, it is determined whether information in the EA packet, the EA auxiliary packet, or the PA packet is matched to the information stored in the intermediate audio device (labeled as “Match?” in FIG. 4 for brevity). If Yes, Step S404 is entered; if No, Step S400 is entered.

Specifically, in some embodiments, the BT controller in the intermediate audio device receives the EA packet and the EA auxiliary packet, and transmits an EA report to the host, wherein the EA report includes the advertising address and the advertising data ADV_DATA_EA of the EA auxiliary packet, and the advertising data ADV_DATA_EA includes the broadcast ID and the broadcast name. In some embodiments, the host determines whether the advertising address from the EA report matches to one device address among device addresses stored in the intermediate audio device. The host determines to relay the audio broadcast transmission B_P when the advertising address from the EA report matches to one device address among the device addresses. The host determines not to relay the audio broadcast transmission B_P when the advertising address from the EA report does not match to any device address among the device addresses. If the host determines not to relay the audio broadcast transmission B_P, the host does not instruct the BT controller to receive the PA packet.

In some embodiments, the host determines whether the broadcast name matches to information stored in the intermediate audio device. In this embodiment, the information stored in the intermediate audio device includes a keyword related to a help. The host determines to relay the audio broadcast transmission B_P when the broadcast name matches to the information stored in the intermediate audio device. The host determines not to relay the audio broadcast transmission B_P when the broadcast name does not match to the information stored in the intermediate audio device. If the host determines not to relay the audio broadcast transmission, the host does not instruct the BT controller to receive the PA packet.

In some embodiments, the BT controller in the intermediate audio device receives the EA packet, the EA auxiliary packet, and the PA packet, and transmits an EA report and a PA report to the host, wherein the EA report includes the advertising address and the advertising data ADV_DATA_EA of the EA auxiliary packet, and the PA report includes the advertising data ADV_DATA_PA of the PA packet. The host determines whether the part of the program information matches to information stored in the intermediate audio device. In this embodiment, the information stored in the intermediate audio device includes a keyword related to a help. The host determines to relay the audio broadcast transmission B_P when the part of the program information matches to the information stored in the intermediate audio device. The host determines not to relay the audio broadcast transmission B_P when the part of the program information does not match to the information stored in the intermediate audio device. If the host determines not to relay the audio broadcast transmission B_P, the host does not instruct the BT controller to receive the BIG.

The above embodiments can be used in combination. For example, the host determines whether the advertising address matches to a stored advertising address of a device and determines whether the broadcast name or the part of the program information matches to the stored information. If the advertising address matches to the stored advertising address of the device, or the broadcast name or the part of the program information matches to the stored information, it is determined to relay the audio broadcast transmission B_P.

In Step S404, a BIG of the audio broadcast transmission B_P is received synchronically. The BIG includes multiple BISes carrying the SOS speech.

Specifically, the intermediate audio device performs a reception to the BIG based on the BIGinfo field in the PA packet. The intermediate audio device performs a synchronized reception to a first BIG in the audio broadcast transmission B_P at a time point determined based on the BIGinfo field. The intermediate audio device determines anchors for receiving following BIGs based on the time point and interval information in the BIGinfo field.

FIG. 5 shows a second scheme. In the second scheme, the intermediate audio device determines whether to relay audio broadcast transmission based on at least one of the advertising data ADV_DATA_EA in the EA auxiliary packet and the advertising data ADV_DATA_PA in the PA packet.

In Step S500, a scanning operation is performed by the intermediate audio device to receive an EA packet and EA auxiliary packet of the audio broadcast transmission B_P.

In Step S502, it is determined whether the broadcast ID carried in the EA packet of the audio broadcast transmission B_P is a new broadcast ID (labeled as “New?” in FIG. 5 for brevity). If Yes, Step 504 is entered; if No, Step S500 is entered. That is, in response to the broadcast ID not being the new broadcast ID, the scanning operation is re-performed to receive another EA packet.

In response to the broadcast ID not being the new broadcast ID, the intermediate audio device does not generate an intermediate audio broadcast transmission I_P for the broadcast ID. Specifically, the intermediate audio device does not receive the PA packet in the audio broadcast transmission B_P based on the EA auxiliary packet, wherein the PA packet includes a BIGinfo field, and the BIGinfo field includes information for helping the intermediate audio device to perform a reception of the BIG in the audio broadcast transmission B_P. Because the intermediate audio device does not receive the PA packet in the audio broadcast transmission B_P, the intermediate audio device does not receive the audio broadcast streams in the BIG.

In some embodiments, this step may not be performed in an emergency rescue scenario.

In Step S504, a PA packet of the audio broadcast transmission B_P is received. In response to the broadcast ID being the new broadcast ID, the intermediate audio device performs a reception to the PA packet.

In Step S506, it is preliminarily determined whether the audio broadcast transmission B_P needs to be relayed (labeled as “Relay?” in FIG. 5 for brevity). If Yes, Step S508 is entered; if No, Step S500 is entered. That is, in response to the audio broadcast transmission B_P not needing to be relayed, the scanning operation is re-performed to receive another EA packet.

In this step, the intermediate audio device determines whether to forward the broadcast streams based on the text information for acting as the broadcast name in the advertising data ADV_DATA_EA of the EA auxiliary packet or the part of the program information of the PA packet, wherein the text information indicates a help keyword. For example, the intermediate audio device displays the broadcast name and the part of the program information for the user to determine whether to forward the broadcast streams in the audio broadcast transmission B_P. The electronic device 10 further receives the instruction indicating whether the audio broadcast streams need to be forwarded.

Specifically, the BT controller in the intermediate audio device transmits an EA report to the host, wherein the EA report includes the advertising address and the advertising data ADV_DATA_EA of the EA auxiliary packet, and the advertising data ADV_DATA_EA includes the broadcast ID and the broadcast name. The host finds the broadcast ID is new and indicates the BT controller to receive the PA packet. The BT controller receives the PA packet and sends a PA report to the host, wherein the PA report includes the advertising data ADV_DATA_PA of the PA packet. The host determines whether to relay the audio broadcast transmission based on the broadcast name in the advertising data ADV_DATA_EA or the part of the program information in the advertising data ADV_DATA_PA, wherein the broadcast name in the advertising data ADV_DATA_EA or the part of the program information in the advertising data ADV_DATA_PA is the text information indicating a help keyword. For example, the host displays the text information indicating the help keyword for the user to preliminarily determine whether to forward the broadcast streams in the audio broadcast transmission B_P. The host may further receive a user-triggered instruction indicating the broadcast streams need to be forwarded.

In Step S508, a BIG in the audio broadcast transmission B_P is received. The BIG includes multiple BISes carrying the SOS speech.

In some embodiments, the intermediate audio device may receive the BIG in the audio broadcast transmission B_P after receiving an instruction triggered by a user indicating the need to forward the broadcast stream.

In Step S510, the intermediate audio device plays the SOS speech to the user.

In Step S512, the intermediate audio broadcast transmission I_P is generated and transmitted after an indication indicating that the played SOS speech needing to be forwarded is triggered by the user.

It should be noted that the schemes shown in FIGS. 4 and 5 may be combined.

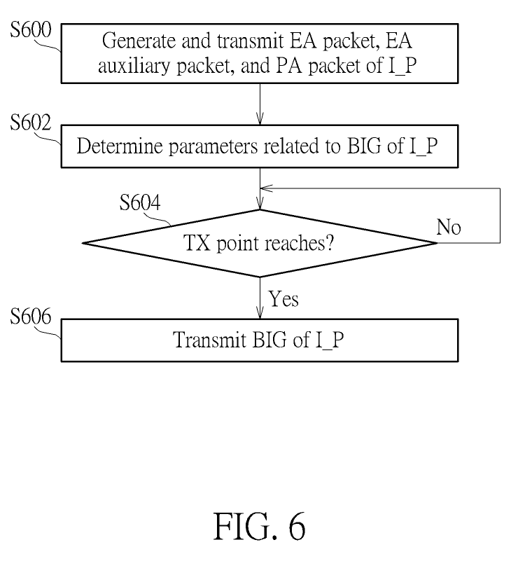

FIG. 6 illustrates a working flow of a method for forwarding an audio broadcast stream according to an embodiment of the present invention. The method shown in FIG. 6 may be employed by the electronic device 10 shown in FIG. 1, wherein the electronic device 10 supports the Auracast broadcast audio function, and may acts as both the BMS and the BMR. For better comprehension, the method may be illustrated with the working flow shown in FIG. 6, but the present invention is not limited thereto. In some embodiments, one or more steps may be added, deleted, or changed in the working flow shown in FIG. 6.

In Step S600, according to the EA packet, the EA auxiliary packet, and the PA packet of the audio broadcast transmission B_P, an EA packet, an EA auxiliary packet, and a PA packet of the intermediate audio broadcast transmission I_P are generated and transmitted, wherein frequency hopping algorithm-related parameters of the intermediate audio broadcast transmission I_P is different from that of the audio broadcast transmission B_P.

In some embodiments, the EA packet and the EA auxiliary packet of the intermediate audio broadcast transmission I_P are transmitted before a first BIG of at least one BIGes in the audio broadcast transmission B_P is transmitted.

In some embodiments, the EA packet and the EA auxiliary packet of intermediate audio broadcast transmission I_P are transmitted after a first BIG of at least one BIGes in the audio broadcast transmission B_P is transmitted.

The intermediate audio device may use a part of advertising data, such as the advertising data ADV_DATA_EA in the EA auxiliary packet of the audio broadcast transmission B_P and the advertising data ADV_DATA_PA in the PA packet of the audio broadcast transmission B_P, to generate the EA auxiliary packet and the PA packet of the intermediate audio broadcast transmission I_P, wherein the advertising data ADV_DATA_EA includes the broadcast name indicating a help keyword, or the advertising data ADV_DATA_PA includes the program information indicating a help keyword. The broadcast ID included in the advertising data ADV_DATA_EA of the intermediate audio broadcast transmission I_P is the same as that of the audio broadcast transmission B_P. In some embodiments, the Public Broadcast Announcement (PBA) in the EA auxiliary packet included in the intermediate audio broadcast transmission I_P is the same as that in the EA auxiliary packet included in the audio broadcast transmission B_P. A basic Audio Announcements in the PA packet included in the intermediate audio broadcast transmission I_P is the same as that in the PA packet included in the audio broadcast transmission B_P. The text information in the intermediate audio broadcast transmission I_P is the same as that in the audio broadcast transmission B_P. The location information of the electronic device 10 carried in the intermediate audio broadcast transmission I_P is the same as that in the audio broadcast transmission B_P.

In Step 602, according to multiple parameters related to the BIG of the audio broadcast transmission B_P, parameters related to the BIG of the intermediate audio broadcast transmission I_P are determined, wherein the multiple parameters may be included in the basic audio announcement service (BAAS)of the PA packet included in the audio broadcast transmission B_P.

In Step S604, it is determined whether a transmission anchor point reaches for transmitting the BIG of the intermediate audio broadcast transmission I_P (labeled as “TX point reaches?” in FIG. 6 for brevity), wherein the audio data is included in the BIG of the intermediate audio broadcast transmission I_P. If Yes, Step S606 is entered. If No, Step S604 is returned for determining whether the transmission anchor point reaches again.

In Step S606, the BIG of the intermediate audio broadcast transmission I_P is transmitted. The BIG includes multiple BISes carrying the SOS speech.

In some embodiments, one intermediate BIG of the intermediate audio broadcast transmission I_P is transmitted between the reception of two BIGes of the audio broadcast transmission B_P.

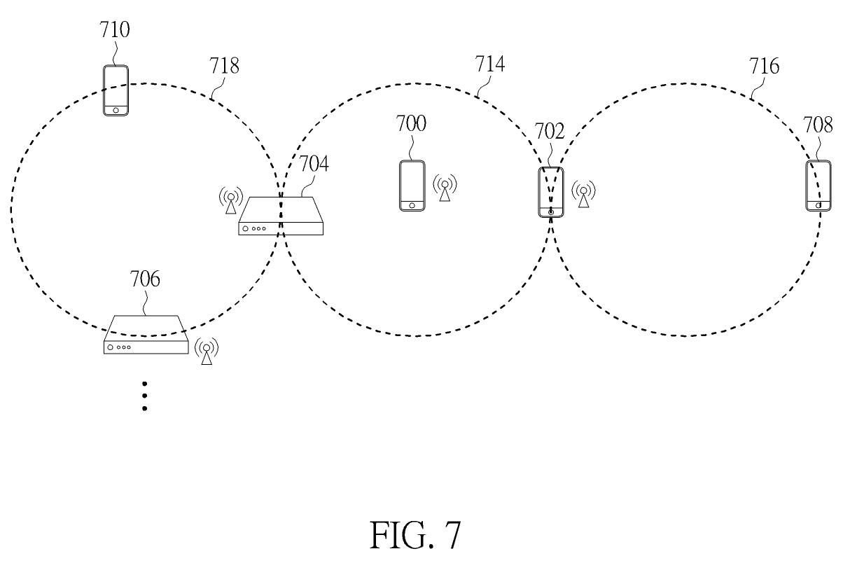

FIG. 7 is a diagram illustrating an example of broadcasting/relaying the audio broadcast transmission B_P according to an embodiment of the present invention, wherein an electronic device 700 is an audio source device acting as the BMS; electronic devices 708 and 710 acts as the BMR; and electronic devices 702, 704, and 706 act as both the BMS and the BMR. Assume that a user U_1 of the electronic device 700 is in the emergency rescue scenario without the network (e.g., the user U_1 is a user seeking a rescue). If the user U_1 desires to broadcast the SOS information, the user U_1 may enable the Bluetooth broadcast audio function of the electronic device 700 to broadcast the audio broadcast transmission B_P over the air for information propagation, wherein the first part of the advertising data ADV_DATA_EA of the EA auxiliary packet or the first part of the advertising data ADV_DATA_PA of the PA packet included in the audio broadcast transmission B_P carries the text information (e.g., a help keyword), the second part of the advertising data ADV_DATA_EA of the EA auxiliary packet or the second part of the advertising data ADV_DATA_PA of the PA packet included in the audio broadcast transmission B_P carries the position information of the electronic device 700, and the BIS of the audio broadcast transmission B_P carries the audio information (e.g., a SOS speech recorded by the user U_1).

For example, a broadcast range of the audio broadcast transmission B_P corresponding to the electronic device 700 may be a circle 714, wherein an electronic device within the circle 714 may determine whether to relay the audio broadcast transmission B_P. More particularly, the electronic device 702 may broadcast the intermediate audio broadcast transmission I_P over the air within a broadcast range being a circle 716. In this way, the propagation distance of the text information, the position information, and the SOS speech in the audio broadcast transmission B_P can be increased. Assume that a user of the electronic device 708 is a rescuer. The electronic device 708 within the circle 716 that acts as the BMR may receive the intermediate audio broadcast transmission I_P with the text information, the position information, and the SOS speech transmitted by the electronic device 702, and the rescuer may provide real-time assistance according to the text information, the position information, and the SOS speech carried by the intermediate audio broadcast transmission I_P. In this case, the electronic device 702 may use the method shown in FIG. 5 to determine whether to relay.

In this embodiment, each of the electronic devices 704 and 706 may be a fixed-position reception device. For example, after receiving the audio broadcast transmission B_P broadcasted by the electronic device 700, the electronic device 704 may broadcast the intermediate audio broadcast transmission I_P over the air within a broadcast range being a circle 718, so that the propagation distance of the text information, the position information, and the SOS speech in the audio broadcast transmission B_P can be increased. The electronic device 706 within the circle 718 may receive the intermediate audio broadcast transmission I_P, and broadcast another intermediate audio broadcast transmission over the air within a broadcast range being another circle (not shown in FIG. 8), so that the propagation distance of the text information, the position information, and the SOS speech is further increased. In this case, the fixed-position reception device may use the method shown in FIG. 4 to determine whether to relay.

It should be noted that, FIG. 7 is for illustration only, and the present invention is not limited thereto. In some embodiments, content of the audio broadcast transmission B_P can be forwarded via more electronic devices that act as both the BMS and the BMR, in order to further increase the propagation distance of the content of the audio broadcast transmission B_P.

In summary, the electronic device of the present invention acting as the BMS can broadcast the audio broadcast transmission B_P with more information, wherein the EA auxiliary packet or the PA packet of the audio broadcast transmission B_P includes the text information, the EA auxiliary packet or the PA packet of the audio broadcast transmission B_P includes the position information of the electronic device, a BIS of the audio broadcast transmission B_P includes the audio data, and the electronic device can further translate the audio data into translated audio data in different language versions. More particularly, electronic devices acting as both the BMS and the BMR can receive and forward the content of the audio broadcast transmission B_P, so that a propagation distance of the content of the audio broadcast transmission B_P can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for broadcasting an audio broadcast transmission by an electronic device, comprising:
determining text information for acting as a first part of advertising data of a first extended advertising (EA) auxiliary packet or a first part of advertising data of a first periodic advertising (PA) packet, wherein the text information indicates a help keyword;
determining audio information for acting as audio data of a first broadcast isochronous stream (BIS), wherein the audio information comprises audio data of at least one speech seeking for help;
obtaining position information of the electronic device for acting as a second part of the advertising data of the first EA auxiliary packet or a second part of the advertising data of the first PA packet, wherein the position information of the electronic device indicates a position of the electronic device; and
broadcasting the audio broadcast transmission, wherein the audio broadcast transmission comprises an EA packet, the first EA auxiliary packet, the first PA packet, and the first BIS.

2. The method of claim 1, wherein the text information acts as a broadcast name in the advertising data of the first EA auxiliary packet, or the text information acts as a part of program information in the advertising data of the first PA packet.

3. The method of claim 1, wherein the at least one speech seeking for help comprises an original speech seeking for help, and the method further comprises:
translating the original speech seeking for help into at least one translated speech,
wherein the at least one speech seeking for help comprises multiple-language speeches, and the multiple-language speeches comprise the original speech seeking for help and the at least one translated speech.

4. The method of claim 1, wherein the audio broadcast transmission comprises multiple EA auxiliary packets sent periodically, multiple PA packets sent periodically, and multiple broadcast isochronous groups (BIGs) sent periodically; the first EA auxiliary packet is comprised in the multiple EA auxiliary packets; the first PA packet is comprised in the multiple PA packets; each of the multiple BIGs comprises at least one BIS; a period of the multiple EA auxiliary packets is a first period; a period of the multiple PA auxiliary packets is a second period; a period of the multiple BIGs is a third period; and the method further comprises:
receiving an instruction for updating the audio information in order to generate updated audio information, wherein the updated audio information is carried in a second BIS comprised in a BIG which is sent after the instruction is received.

5. The method of claim 1, wherein the audio broadcast transmission comprises multiple EA auxiliary packets sent periodically, multiple PA packets sent periodically, and multiple broadcast isochronous groups (BIGs) sent periodically; the first EA auxiliary packet is comprised in the multiple EA auxiliary packets; the first PA packet is comprised in the multiple PA packets; each of the multiple BIGs comprises at least one BIS; a period of the multiple EA auxiliary packets is a first period; a period of the multiple PA auxiliary packets is a second period; a period of the multiple BIGs is a third period; and the method further comprises:
receiving an instruction for updating the text information in order to generate updated text information, wherein the updated text information acts as a first part of advertising data of a second EA auxiliary packet which is sent after the instruction is received and comprised in the multiple EA auxiliary packets, or acts as a first part of advertising data of a second PA packet which is sent after the instruction is received and comprised in the multiple PA packets.

6. The method of claim 1, wherein the audio broadcast transmission comprises multiple EA auxiliary packets sent periodically, multiple PA packets sent periodically, and multiple broadcast isochronous groups (BIGs) sent periodically; the first EA auxiliary packet is comprised in the multiple EA auxiliary packets; the first PA packet is comprised in the multiple PA packets; each of the multiple BIGs comprises at least one BIS; a period of the multiple EA auxiliary packets is a first period; a period of the multiple PA auxiliary packets is a second period; a period of the multiple BIGs is a third period; and the method further comprises:
in response to determining that the position of the electronic device is changed, updating the position information in order to generate updated position information; and
utilizing the updated location information as the second part of the advertising data of a second EA auxiliary packet which is sent after the position of the electronic device is changed and comprised in the multiple EA auxiliary packets, or the second part of the advertising data of a second PA packet which is sent after the position of the electronic device is changed and comprised in the multiple PA packets.

7. The method of claim 1, wherein the audio broadcast transmission comprises multiple broadcast isochronous groups (BIGs), each of the multiple BIGs comprises at least one BIS, and the method further comprises:
extending a time interval for broadcasting said each of the multiple BIGs in an emergency rescue scenario without a network.

8. A method for forwarding audio broadcast streams by an electronic device, comprising:
receiving an extended advertising (EA) packet, an EA auxiliary packet, a periodic advertising (PA) packet, and a broadcast isochronous stream (BIS) from a first electronic device, wherein the broadcast transmission comprises the EA packet, the EA auxiliary packet, the PA packet, and the BIS; a first part of advertising data of the EA auxiliary packet or a first part of advertising data of the PA packet carries text information; the text information indicates a help keyword; a second part of the advertising data of the EA auxiliary packet or a second part of the advertising data of the PA packet carries position information of the first electronic device; the position information of the electronic device indicates a position of the first electronic device; the BIS carries the audio broadcast streams; and the audio broadcast streams carry audio data of at least one speech seeking for help;
determining whether the audio broadcast streams need to be forwarded based on at least one of the EA packet, the EA auxiliary packet, the PA packet, and the audio data of the at least one speech seeking for help; and
in response to the audio broadcast streams needing to be forwarded, transmitting an intermediate audio broadcast transmission according to the audio broadcast transmission, wherein the intermediate audio broadcast transmission comprises an intermediate EA packet, an intermediate EA auxiliary packet, an intermediate PA packet, and an intermediate BIS; and the intermediate BIS carries the audio broadcast streams.

9. The method of claim 8, wherein the text information acts as a broadcast name in the advertising data of the EA auxiliary packet, or the text information acts as a part of program information in the advertising data of the PA packet.

10. The method of claim 8, wherein the at least one speech seeking for help comprises multiple-language speeches, and the multiple-language speeches comprise an original speech seeking for help and at least one translated speech corresponding to the original speech seeking for help.

11. The method of claim 9, wherein the step of determining whether the audio broadcast streams need to be forwarded based on the at least one of the EA packet, the EA auxiliary packet, the PA packet, and the audio data of the at least one speech seeking for help comprises:
determining whether the broadcast name in the advertising data of the EA auxiliary packet or the part of the program information in the advertising data of the PA packet matches to stored information; and
in response to the broadcast name or the part of the program information matching to the stored information, determining the audio broadcast streams need to be forwarded.

12. The method of claim 8, wherein the step of determining whether the audio broadcast streams need to be forwarded based on the at least one of the EA packet, the EA auxiliary packet, the PA packet, and the audio data of the at least one speech seeking for help comprises:
determining whether an advertising address in the EA packet matches to one of device addresses stored in the electronic device; and
in response to the advertising address matching to said one of the device addresses stored in the electronic device, determining that the audio broadcast streams need to be forwarded.

13. The method of claim 9, wherein the step of determining whether the audio broadcast streams need to be forwarded based on the at least one of the EA packet, the EA auxiliary packet, the PA packet, and the audio data of the at least one speech seeking for help comprises:
displaying the broadcast name or the part of the program information; and
receiving an instruction for indicating the audio broadcast streams need to be forwarded from a user of the electronic device.

14. The method of claim 9, wherein the step of determining whether the audio broadcast streams need to be forwarded based on the at least one of the EA packet, the EA auxiliary packet, the PA packet, and the audio data of the at least one speech seeking for help comprises:
displaying the broadcast name or the part of the program information;
displaying the position information;
receiving a first instruction for indicating playing the audio broadcast streams from a user of the electronic device;
playing the audio broadcast streams; and
receiving a second instruction indicating the audio broadcast streams need to be forwarded from the user.

15. An electronic device, comprising:
a processor, configured to:
determine text information for acting as a first part of advertising data of a first extended advertising (EA) auxiliary packet or a first part of advertising data of a first periodic advertising (PA) packet, wherein the text information indicates a help keyword;
determine audio information for acting as audio data of a first broadcast isochronous stream (BIS), wherein the audio information comprises audio data of at least one speech seeking for help; and
obtain position information of the electronic device for acting as a second part of the advertising data of the first EA auxiliary packet or a second part of the advertising data of the first PA packet, wherein the position information of the electronic device indicates a position of the electronic device; and
a wireless communication module, configured to broadcast the audio broadcast transmission, wherein the audio broadcast transmission comprises an EA packet, the first EA auxiliary packet, the first PA packet, and the first BIS.

16. The electronic device of claim 15, wherein the text information acts as a broadcast name in the advertising data of the first EA auxiliary packet, or the text information acts as a part of program information in the advertising data of the first PA packet.

17. The electronic device of claim 15, wherein the at least one speech seeking for help comprises an original speech seeking for help, and the processor is further configured to translate the original speech seeking for help into at least one translated speech, wherein the at least one speech seeking for help comprises multiple-language speeches, and the multiple-language speeches comprise the original speech seeking for help and the at least one translated speech.

18. The electronic device of claim 15, wherein the audio broadcast transmission comprises multiple EA auxiliary packets sent periodically, multiple PA packets sent periodically, and multiple broadcast isochronous groups (BIGs) sent periodically; the first EA auxiliary packet is comprised in the multiple EA auxiliary packets; the first PA packet is comprised in the multiple PA packets; each of the multiple BIGs comprises at least one BIS; a period of the multiple EA auxiliary packets is a first period; a period of the multiple PA auxiliary packets is a second period; a period of the multiple BIGs is a third period; the processor is further configured to receive an instruction for updating the audio information in order to generate updated audio information; and the updated audio information is carried in a second BIS within a BIG which is sent after the instruction is received.

19. The electronic device of claim 15, wherein the audio broadcast transmission comprises multiple EA auxiliary packets sent periodically, multiple PA packets sent periodically, and multiple broadcast isochronous groups (BIGs) sent periodically; the first EA auxiliary packet is comprised in the multiple EA auxiliary packets; the first PA packet is comprised in the multiple PA packets; each of the multiple BIGs comprises at least one BIS; a period of the multiple EA auxiliary packets is a first period; a period of the multiple PA auxiliary packets is a second period; a period of the multiple BIGs is a third period; the processor is further configured to receive an instruction for updating the text information in order to generate updated text information; and the updated text information acts as a first part of advertising data of a second EA auxiliary packet which is sent after the instruction is received and comprised in the multiple EA auxiliary packets, or acts as a first part of advertising data of a second PA packet which is sent after the instruction is received and comprised in the multiple PA packets.

20. The electronic device of claim 15, wherein the audio broadcast transmission comprises multiple broadcast isochronous groups (BIGs); each of the multiple BIGs comprises at least one BIS; and the processor is configured to extend a time interval for broadcasting said each of the multiple BIGs in an emergency rescue scenario without a network.
